(19) United States
(12) Patent Application Publication
(10) Pub. No.: US 2024/0046038 A1
(43) Pub. Date: Feb. 8, 2024

(54) OPINION AGGREGATION DEVICE, OPINION AGGREGATION METHOD, AND PROGRAM

(71) Applicant: NIPPON TELEGRAPH AND TELEPHONE CORPORATION, Tokyo (JP)

(72) Inventors: Tsukasa YOSHIDA, Tokyo (JP); Atsushi OTSUKA, Tokyo (JP); Narichika NOMOTO, Tokyo (JP); Satoshi KOBASHIKAWA, Tokyo (JP)

(73) Assignee: NIPPON TELEGRAPH AND TELEPHONE CORPORATION, Tokyo (JP)

(21) Appl. No.: 18/267,437

(22) PCT Filed: Dec. 16, 2020
(86) PCT No.: PCT/JP2020/047000

§ 371 Date: Jun. 14, 2023

(51) Int. Cl. G06F 40/289; G06F 16/33

(52) U.S. Cl. CPC G06F 40/289; G06F 16/3344

(57) ABSTRACT

An opinion aggregation apparatus 100 includes: a first determining unit 10 which determines whether an input sentence is a declarative sentence or an interrogative sentence; a first generating unit 20 which generates, when the input sentence is the declarative sentence, first text data being the input sentence converted into an interrogative sentence; a second generating unit 30 which generates, when the input sentence is the interrogative sentence, second text data being a simple answer to the input sentence; a storage unit 120 which stores a chat text database including a plurality of pieces of chat text data; a calculating unit 40 which calculates a first score indicating sentence continuity between the first text data and the chat text data or a second score indicating sentence continuity between the chat text data and the second text data; and a second determining unit 50 which outputs, when the first score or the second score is equal to or higher than a threshold, the chat text data with the first score or the second score.

### TECHNICAL FIELD

The present disclosure relates to an opinion aggregation apparatus, an opinion aggregation method, and a program.

### BACKGROUND ART

In recent years, live streaming is actively performed due to the development of Internet communication and online presentations often take place. In such an environment, comments on a live stream are collected using a chat function. If a streamer is able to respond to gathered opinions or questions in real time, an improvement in the understanding or satisfaction of viewers can be expected. Furthermore, the ability of the streamer to respond in real time is also conducive to a vigorous exchange of opinions and is expected to be particularly useful in presentations in terms of consensus building. However, when a large amount of comments are collected, it is practically impossible for the streamer to check every single comment during streaming and there is a need for a technique for compiling and organizing similar opinions or questions from chat sentences.

For example, PTL 1 discloses a microblog text classification technique for achieving high classification accuracy based on a long-term tendency while being adapted at a high speed to a tendency change of a specified text collection.

### CITATION LIST

### Patent Literature

[PTL 1] Japanese Patent Application Publication No. 2012-221430

### SUMMARY OF INVENTION

### Technical Problem

However, in the prior art, while topic classification is achieved by retrieval of related texts, it is impossible to perform classification based on captured semantic information of same opinions or same meanings and, consequently, organizing similar opinions or questions is difficult. In addition, since a text is first converted into a feature vector, there is a problem in that it is difficult to interpret a classification result and that it is difficult to perform an error analysis or the like by viewing an interim result.

An object of the present disclosure having been devised in consideration of the circumstances described above is to provide an opinion aggregation apparatus, an opinion aggregation method, and a program which are capable of performing classification based on captured semantic information.

### Solution to Problem

An opinion aggregation apparatus according to an embodiment includes: a first determining unit which determines whether an input sentence is a declarative sentence or an interrogative sentence; a first generating unit which generates, when the input sentence is the declarative sentence, first text data being the input sentence converted into an interrogative sentence; a second generating unit which generates, when the input sentence is the interrogative sentence, second text data being a simple answer to the input sentence; a storage unit which stores a chat text database including a plurality of pieces of chat text data; a calculating unit which calculates a first score indicating sentence continuity between the first text data and the chat text data or a second score indicating sentence continuity between the chat text data and the second text data; and a second determining unit which outputs, when the first score or the second score is equal to or higher than a threshold, the chat text data with the first score or the second score.

An opinion aggregation method according to an embodiment includes the steps of: determining whether an input sentence is a declarative sentence or an interrogative sentence; generating, when the input sentence is the declarative sentence, first text data being the input sentence converted into an interrogative sentence; generating, when the input sentence is the interrogative sentence, second text data being a simple answer to the input sentence; storing a chat text database including a plurality of pieces of chat text data; calculating a first score indicating sentence continuity between the first text data and the chat text data or a second score indicating sentence continuity between the chat text data and the second text data; and outputting, when the first score or the second score is equal to or higher than a threshold, the chat text data with the first score or the second score.

A program according to an embodiment causes a computer to function as the opinion aggregation apparatus described above.

### Advantageous Effects of Invention

According to the present disclosure, an opinion aggregation apparatus, an opinion aggregation method, and a program which are capable of performing classification based on captured semantic information can be provided.

### BRIEF DESCRIPTION OF DRAWINGS

FIG. 1 is a diagram showing an example of a configuration of an opinion aggregation apparatus according to a first embodiment.

FIG. 2 is a diagram showing an example of each piece of data according to the first embodiment.

FIG. 3 is a diagram showing an example of each piece of data according to the first embodiment.

FIG. 4 is a flow chart showing an example of an opinion aggregation method according to the first embodiment.

FIG. 5 is a diagram showing an example of a configuration of an opinion aggregation apparatus according to a second embodiment.

FIG. 6 is a diagram showing an example of each piece of data according to the second embodiment.

FIG. 7 is a flow chart showing an example of an opinion aggregation method according to the second embodiment.

### DESCRIPTION OF EMBODIMENTS

Hereinafter, modes for carrying out the present invention will be described in detail with reference to the drawings.

### First Embodiment

<Configuration of Opinion Aggregation Apparatus>

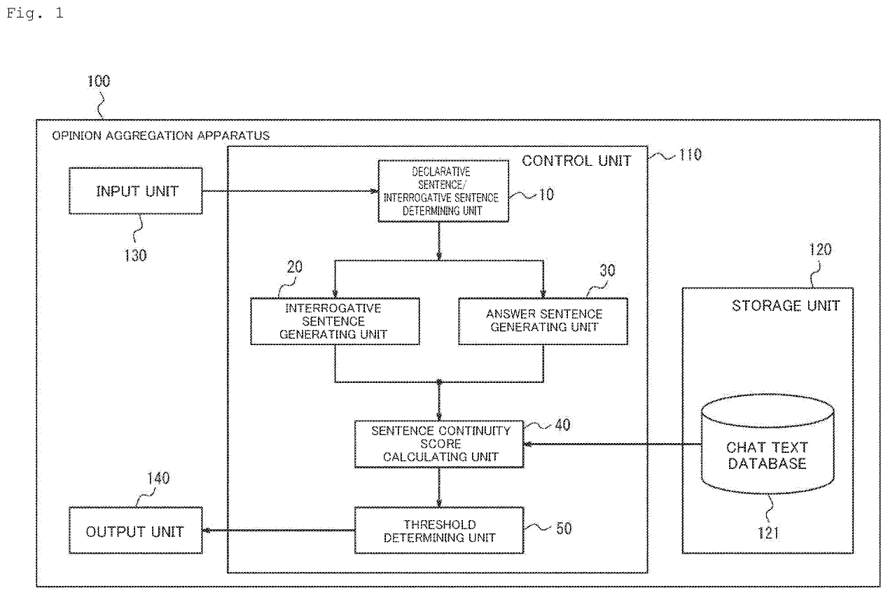

First, an example of a configuration of an opinion aggregation apparatus according to a first embodiment will be described with reference to FIGS. 1 to 3.

An opinion aggregation apparatus 100 includes a control unit 110, a storage unit 120, an input unit 130, and an output unit 140.

The control unit 110 may be constituted by dedicated hardware or constituted by a general-purpose processor or a processor specialized for specific processing. The control unit 110 includes a declarative sentence/interrogative sentence determining unit (first determining unit) 10, an interrogative sentence generating unit (first generating unit) 20, an answer sentence generating unit (second generating unit) 30, a sentence continuity score calculating unit (calculating unit) 40, and a threshold determining unit (second determining unit) 50.

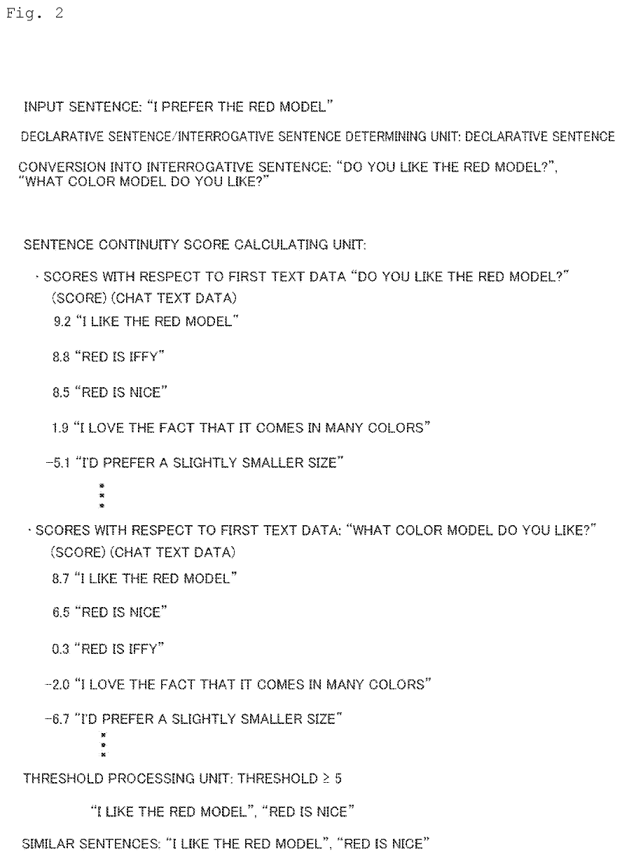

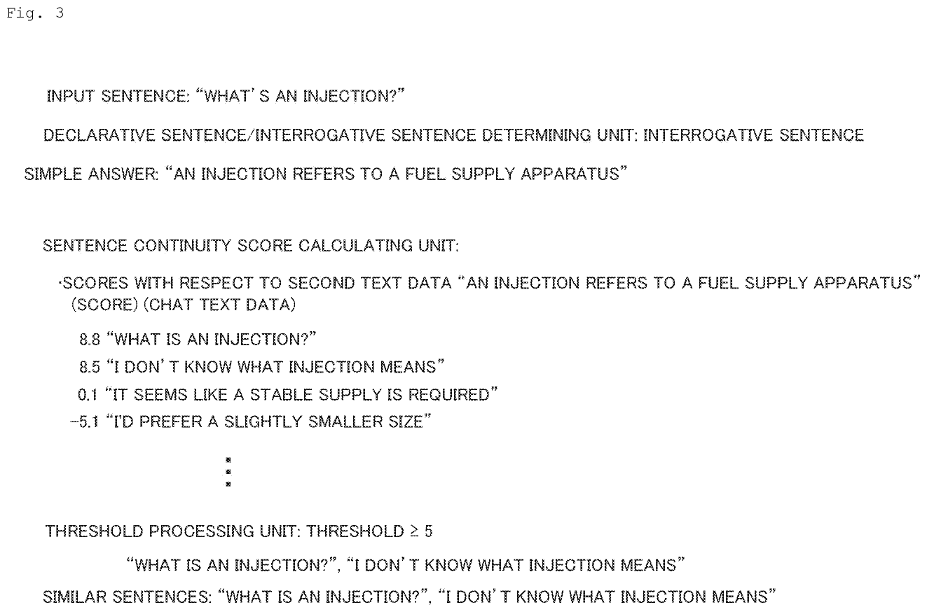

The storage unit 120 includes one or more memories and may include, for example, a semiconductor memory, a magnetic memory, an optical memory, and so on. Each of the memories included in the storage unit 120 may function as, for example, a main storage apparatus, an auxiliary storage apparatus, or a cache memory. Each memory need not necessarily be included inside the opinion aggregation apparatus 100 and may be provided as an external component of the opinion aggregation apparatus 100. The storage unit 120 stores arbitrary information to be used to operate the opinion aggregation apparatus 100. The storage unit 120 stores, for example, a chat text database 121 including a plurality of pieces of chat text data. Examples of the chat text data include, as shown in FIG. 2, “I like the red model”, “Red is iffy”, “Red is nice”, “I love the fact that it comes in many colors”, and “I'd prefer a slightly smaller size”. Examples of the chat text data include, as shown in FIG. 3, “What is an injection?”, “I don't know what injection means”, “It seems like a stable supply is required”, and “I'd prefer a slightly smaller size”. In addition to the above, the storage unit 120 stores various programs, data, or the like.

The input unit 130 receives inputs of various types of information. The input unit 130 may be any kind of device as long as predetermined operations can be performed by a user, and examples thereof include a microphone, a touch panel, a keyboard, and a mouse. For example, an input sentence is input to the control unit 110 by a user by performing a predetermined operation using the input unit 130. An example of an input sentence is, as shown in FIG. 2, “I prefer the red model (declarative sentence)”. An example of an input sentence is, as shown in FIG. 3, “What's an injection? (interrogative sentence)”. The input unit 130 may be provided outside of the opinion aggregation apparatus 100 or integrated with the opinion aggregation apparatus 100.

The output unit 140 outputs various types of information. The output unit 140 is, for example, a speaker, a liquid crystal display, or an organic EL (Electro-Luminescence) display. For example, the output unit 140 outputs a similar sentence that is similar to an input sentence. Examples of a similar sentence that is similar to an input sentence include, as shown in FIG. 2, “I like the red model” and “Red is nice” with respect to the input sentence “I prefer the red model”. Examples of a similar sentence that is similar to an input sentence include, as shown in FIG. 3, “What is an injection?” and “I don't know what injection means” with respect to the input sentence “What's an injection?” The output unit 140 may be provided outside of the opinion aggregation apparatus 100 or integrated with the opinion aggregation apparatus 100.

The declarative sentence/interrogative sentence determining unit 10 determines whether an input sentence is a declarative sentence or an interrogative sentence. When the input sentence is a declarative sentence, the declarative sentence/interrogative sentence determining unit 10 outputs a determination result that the input sentence is a declarative sentence to the interrogative sentence generating unit 20. When the input sentence is an interrogative sentence, the declarative sentence/interrogative sentence determining unit 10 outputs a determination result that the input sentence is an interrogative sentence to the answer sentence generating unit 30.

The interrogative sentence generating unit 20 converts the input sentence into an interrogative sentence based on the determination result input from the declarative sentence/interrogative sentence determining unit 10 and generates first text data being text data obtained by converting the input sentence into an interrogative sentence. The interrogative sentence generating unit 20 outputs the first text data to the sentence continuity score calculating unit 40. Examples of the first text data include, as shown in FIG. 2, “Do you like the red model?” and “What color model do you like?” With respect to a single input sentence, the interrogative sentence generating unit 20 may generate a single piece of first text data or a plurality of pieces of first text data.

Although a technique used by the interrogative sentence generating unit 20 to generate the first text data is not particularly limited, for example, an automatic question generation technique may be used. For details of an automatic question generation technique, for example, refer to the following literature.

Sato Sato, Hiroyasu Itsui, Manabu Okumura, “Automatic generation of questions from product manual sentences”, JSAI2018 Proceedings, The 32nd Annual Conference of the Japanese Society for Artificial Intelligence (2018), The Japanese Society for Artificial Intelligence.

The answer sentence generating unit 30 prepares a simple answer to the input sentence based on the determination result input from the declarative sentence/interrogative sentence determining unit 10 and generates second text data being text data of the simple answer to the input sentence. The answer sentence generating unit 30 outputs the second text data to the sentence continuity score calculating unit 40. Examples of the second text data include, as shown in FIG. 3, “An injection refers to a fuel supply apparatus”. With respect to a single input sentence, the answer sentence generating unit 30 may generate a single piece of second text data or a plurality of pieces of second text data.

Although a technique used by the answer sentence generating unit 30 to generate the second text data is not particularly limited, for example, an FAQ retrieval system may be used to retrieve a suitable answer to the input sentence and the suitable answer may be summarized and used as a simple answer sentence. For details of this technique, for example, refer to Japanese Patent Application Laid-open No. 2018-180938 and Japanese Patent Application Laid-open No. 2018-147102.

The sentence continuity score calculating unit 40 calculates a first score indicating sentence continuity between the first text data input from the interrogative sentence generating unit 20 and chat text data (for example, “I like the red model”, “Red is iffy”, “Red is nice”, “I love the fact that it comes in many colors”, and “I'd prefer a slightly smaller size”) extracted from the chat text database 121. The sentence continuity score calculating unit 40 outputs the calculated first score to the threshold determining unit 50.

In a similar manner, the sentence continuity score calculating unit 40 calculates a second score indicating sentence continuity between chat text data (for example, “What is an injection?”, “I don't know what injection means”, “It seems like a stable supply is required”, and “I'd prefer a slightly smaller size”) extracted from the chat text database 121 and second text data input from the answer sentence generating unit 30. The sentence continuity score calculating unit 40 outputs the calculated second score to the threshold determining unit 50.

Although a technique used by the sentence continuity score calculating unit 40 to calculate the first score or the second score is not particularly limited, for example, an output value of Next Sentence Prediction being one of learning models of natural language processing may be used as a score indicating sentence continuity. For details of this technique, for example, refer to the following literature.

Devlin, Jacob, et al. “Bert: Pre-training of deep bidirectional transformers for language understanding.” arXiv preprint arXiv:1810.04805 (2018).

For example, the sentence continuity score calculating unit 40 calculates a score indicating sentence continuity between first text data: “Today's weather is fine” and second text data: “Tomorrow's weather is cloudy” as “8.5 (True)”. The score indicates that the continuity between the two sentences “Today's weather is fine” and “Tomorrow's weather is cloudy” is high.

For example, the sentence continuity score calculating unit 40 calculates a score indicating sentence continuity between first text data: “Today's weather is fine” and second text data: “Probability statistics is an important subject” as “−5.4 (False)”. The score indicates that the continuity between the two sentences “Today's weather is fine” and “Probability statistics is an important subject” is low.

The score indicating sentence continuity can be set within a range from −∞ to +∞. The sentence continuity score calculating unit 40 outputs True when, for example, a value of the score indicating sentence continuity is positive. The sentence continuity score calculating unit 40 outputs False when, for example, a value of the score indicating sentence continuity is negative.

Based on the first scores or the second scores input from the sentence continuity score calculating unit 40, the threshold determining unit 50 ranks a plurality of pieces of chat text data in an order of the scores. For example, as shown in FIG. 2, the threshold determining unit 50 ranks the plurality of pieces of chat text data with respect to first text data: “Do you like the red model?” as follows: “9.2: I like the red model”, “8.8: Red is iffy”, “8.5: Red is nice”, “1.9: I love the fact that it comes in many colors”, “−5.1: I'd prefer a slightly smaller size”, and the like. For example, as shown in FIG. 2, the threshold determining unit 50 ranks the plurality of pieces of chat text data with respect to first text data: “What color model do you like?” as follows: “8.7: I like the red model”, “6.5: Red is nice”, “0.3: Red is iffy”, “−2.0: I love the fact that it comes in many colors”, “−6.7: I'd prefer a slightly smaller size”, and the like. For example, as shown in FIG. 3, the threshold determining unit 50 ranks the plurality of pieces of chat text data with respect to second text data: “An injection refers to a fuel supply apparatus” as follows: “8.8: What is an injection?”, “8.5: I don't know what injection means”, “0.1: It seems like a stable supply is required”, “−5.1: I'd prefer a slightly smaller size”, and the like.

In addition, the threshold determining unit 50 determines whether or not the first score is equal to or higher than a threshold. The threshold determining unit 50 outputs chat text data with the first score to the output unit 140 when the first score is equal to or higher than the threshold but does not output the chat text data with the first score to the output unit 140 when the first score is lower than the threshold.

In a similar manner, the threshold determining unit 50 determines whether or not the second score is equal to or higher than a threshold. The threshold determining unit 50 outputs chat text data with the second score to the output unit 140 when the second score is equal to or higher than the threshold but does not output the chat text data with the second score to the output unit 140 when the second score is lower than the threshold.

A value of the threshold is not particularly limited and the threshold may be set to an arbitrary value by the opinion aggregation apparatus 100.

For example, when there is a single piece of first text data, the threshold determining unit 50 determines whether or not a first score of a single piece or a plurality of pieces of chat text data is equal to or higher than a threshold with respect to the first text data. In addition, the threshold determining unit 50 outputs chat text data with the first score to the output unit 140 when the first score is equal to or higher than the threshold but does not output chat text data with the first score to the output unit 140 when the first score is lower than the threshold.

In a similar manner, for example, as shown in FIG. 3, when there is a single piece of second text data, the threshold determining unit 50 determines whether or not a second score of a single piece or a plurality of pieces of chat text data (for example, “What is an injection?”, “I don't know what injection means”, “It seems like a stable supply is required”, and “I'd prefer a slightly smaller size”) is equal to or higher than a threshold (for example, 5.0) with respect to the second text data (for example, “An injection refers to a fuel supply apparatus”). In addition, the threshold determining unit 50 outputs chat text data (for example, “What is an injection?” and “I don't know what injection means”) including the second score to the output unit 140 when the second score is equal to or higher than the threshold but does not output chat text data (for example, “It seems like a stable supply is required” and “I'd prefer a slightly smaller size”) including the second score to the output unit 140 when the second score is lower than the threshold.

For example, as shown in FIG. 2, when there are a plurality of pieces of first text data, the threshold determining unit 50 determines whether or not a first score of a single piece or a plurality of pieces of chat text data (for example, “I like the red model”, “Red is iffy”, “Red is nice”, “I love the fact that it comes in many colors”, and “I'd prefer a slightly smaller size”) is equal to or higher than a threshold (for example, 5.0) with respect to all of the pieces of first text data (for example, “Do you like the red model?” and “What color model do you like?”). In addition, the threshold determining unit 50 outputs chat text data (for example, “I like the red model” and “Red is nice”) of which the first score is equal to or higher than the threshold with respect to all of the pieces of first text data to the output unit 140 but does not output chat text data (for example, “Red is iffy”, “I love the fact that it comes in many colors”, and “I'd prefer a slightly smaller size”) of which the first score is not equal to or higher than the threshold with respect to all of the pieces of first text data to the output unit 140.

In a similar manner, for example, when there are a plurality of pieces of second text data, the threshold determining unit 50 determines whether or not the second score is equal to or higher than a threshold with respect to all of the pieces of second text data. In addition, the threshold determining unit 50 outputs chat text data of which the second score is equal to or higher than the threshold with respect to all of the pieces of second text data to the output unit 140 but does not output chat text data of which the second score is not equal to or higher than the threshold with respect to all of the pieces of second text data to the output unit 140.

When an input sentence is a declarative sentence, the opinion aggregation apparatus 100 according to the first embodiment extracts an answer sentence having a high sentence continuity score with respect to a sentence obtained by converting the input sentence into an interrogative sentence, and when the input sentence is an interrogative sentence, the opinion aggregation apparatus 100 according to the first embodiment extracts an interrogative sentence having a high sentence continuity score with respect to a sentence being a simple answer to the interrogative sentence. Accordingly, since similar sentences that are similar to the input sentence can be output, the opinion aggregation apparatus 100 capable of performing classification based on captured semantic information of same opinions or same meanings can be realized.

<Opinion Aggregation Method>

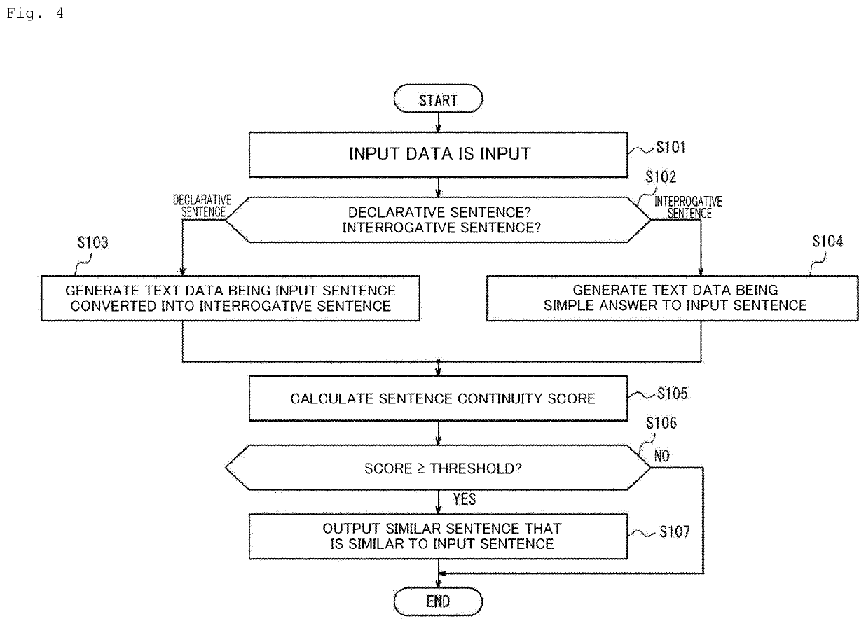

Next, an example of an opinion aggregation method according to the first embodiment will be described with reference to FIG. 4.

In step 101, an input sentence is input to the opinion aggregation apparatus 100. Examples of the input sentence include “I prefer the red model” and “What's an injection?”

In step 102, the opinion aggregation apparatus 100 determines whether the input sentence is a declarative sentence or an interrogative sentence. When the input sentence is a declarative sentence such as “I prefer the red model” (step 102→declarative sentence), the opinion aggregation apparatus 100 performs processing of step 103. When the input sentence is an interrogative sentence such as “What's an injection?” (step 102→interrogative sentence), the opinion aggregation apparatus 100 performs processing of step 104.

In step 103, the opinion aggregation apparatus 100 converts the input sentence into an interrogative sentence and generates first text data that is text data obtained by converting the input sentence into an interrogative sentence. For example, the opinion aggregation apparatus 100 converts an input sentence “I prefer the red model” into an interrogative sentence and generates pieces of first text data that read “Do you like the red model?” and “What color model do you like?”.

In step 104, the opinion aggregation apparatus 100 prepares a simple answer to the input sentence and generates second text data being text data of the simple answer to the input sentence. For example, the opinion aggregation apparatus 100 prepares a simple answer to an input sentence “What's an injection?” and generates second text data that reads “An injection refers to a fuel supply apparatus”.

In step 105, the opinion aggregation apparatus 100 calculates a sentence continuity score. For example, the opinion aggregation apparatus 100 calculates a first score indicating sentence continuity between the first text data and chat text data included in the chat text database 121. For example, the opinion aggregation apparatus 100 calculates a second score indicating sentence continuity between chat text data included in the chat text database 121 and the second text data.

For example, using first text data: “Do you like the red model?” as a first piece of text data and chat text data: “I like the red model” as a second piece of text data, the opinion aggregation apparatus 100 calculates a first score indicating a continuity between the two sentences as “9.2”.

For example, using first text data: “Do you like the red model?” as a first piece of text data and chat text data: “Red is iffy” as a second piece of text data, the opinion aggregation apparatus 100 calculates a first score indicating a continuity between the two sentences as “8.8”.

For example, using first text data: “Do you like the red model?” as a first piece of text data and chat text data: “Red is nice” as a second piece of text data, the opinion aggregation apparatus 100 calculates a first score indicating a continuity between the two sentences as “8.5”.

For example, using first text data: “Do you like the red model?” as a first piece of text data and chat text data: “I love the fact that it comes in many colors” as a second piece of text data, the opinion aggregation apparatus 100 calculates a first score indicating a continuity between the two sentences as “1.9”.

For example, using first text data: “Do you like the red model?” as a first piece of text data and chat text data: “I'd prefer a slightly smaller size” as a second piece of text data, the opinion aggregation apparatus 100 calculates a first score indicating a continuity between the two sentences as “−5.1”.

In a similar manner, for example, using first text data: “What color model do you like?” as a first piece of text data and chat text data: “I like the red model” as a second piece of text data, the opinion aggregation apparatus 100 calculates a first score indicating a continuity between the two sentences as “8.7”.

For example, using first text data: “What color model do you like?” as a first piece of text data and chat text data: “Red is nice” as a second piece of text data, the opinion aggregation apparatus 100 calculates a first score indicating a continuity between the two sentences as “6.5”.

For example, using first text data: “What color model do you like?” as a first piece of text data and chat text data: “Red is iffy” as a second piece of text data, the opinion aggregation apparatus 100 calculates a first score indicating a continuity between the two sentences as “0.3”.

For example, using first text data: “What color model do you like?” as a first piece of text data and chat text data: “I love the fact that it comes in many colors” as a second piece of text data, the opinion aggregation apparatus 100 calculates a first score indicating a continuity between the two sentences as “−2.0”.

For example, using first text data: “What color model do you like?” as a first piece of text data and chat text data: “I'd prefer a slightly smaller size” as a second piece of text data, the opinion aggregation apparatus 100 calculates a first score indicating a continuity between the two sentences as “−6.7”.

In a similar manner, for example, using chat text data: “What is an injection?” as a first piece of text data and second text data: “An injection refers to a fuel supply apparatus” as a second piece of text data, the opinion aggregation apparatus 100 calculates a second score indicating a continuity between the two sentences as “8.8”.

For example, using chat text data: “I don't know what injection means” as a first piece of text data and second text data: “An injection refers to a fuel supply apparatus” as a second piece of text data, the opinion aggregation apparatus 100 calculates a second score indicating a continuity between the two sentences as “8.5”.

For example, using chat text data: “It seems like a stable supply is required” as a first piece of text data and second text data: “An injection refers to a fuel supply apparatus” as a second piece of text data, the opinion aggregation apparatus 100 calculates a second score indicating a continuity between the two sentences as “0.1”.

For example, using chat text data: “I'd prefer a slightly smaller size” as a first piece of text data and second text data: “An injection refers to a fuel supply apparatus” as a second piece of text data, the opinion aggregation apparatus 100 calculates a second score indicating a continuity between the two sentences as “−5.1”.

In step 106, based on the first scores or the second scores, the opinion aggregation apparatus 100 ranks the plurality of pieces of chat text data in an order of the scores.

For example, the opinion aggregation apparatus 100 ranks a plurality of pieces of chat text data with respect to the first text data: “Do you like the red model?” as follows: “9.2: I like the red model”, “8.8: Red is iffy”, “8.5: Red is nice”, “1.9: I love the fact that it comes in many colors”, “−5.1: I'd prefer a slightly smaller size”, and the like.

For example, the opinion aggregation apparatus 100 ranks the plurality of pieces of chat text data with respect to the first text data: “What color model do you like?” as follows: “8.7: I like the red model”, “6.5: Red is nice”, “0.3: Red is iffy”, “−2.0: I love the fact that it comes in many colors”, “−6.7: I'd prefer a slightly smaller size”, and the like.

For example, the opinion aggregation apparatus 100 ranks the plurality of pieces of chat text data with respect to the second text data: “An injection refers to a fuel supply apparatus” as follows: “8.8: What is an injection?”, “8.5: I don't know what injection means”, “0.1: It seems like a stable supply is required”, “−5.1: I'd prefer a slightly smaller size”, and the like.

Subsequently, the opinion aggregation apparatus 100 determines whether or not the first score or the second score is equal to or higher than a threshold. When the first score or the second score is equal to or higher than the threshold (step 106→YES), the opinion aggregation apparatus 100 performs processing of step 107. When the first score or the second score is lower than the threshold (step 106→NO), the opinion aggregation apparatus 100 ends processing.

For example, when there is a single piece of first text data, the opinion aggregation apparatus 100 determines whether or not a first score of chat text data with respect to the first text data is equal to or higher than a threshold. For example, when there are a plurality of pieces of first text data, the opinion aggregation apparatus 100 determines whether or not a first score of chat text data with respect to all of the pieces of first text data is equal to or higher than a threshold.

Specifically, the opinion aggregation apparatus 100 determines that the first score “9.2” of the chat text data: “I like the red model” with respect to the first text data: “Do you like the red model?” is equal to or higher than the threshold and that the first score “8.7” of the chat text data: “I like the red model” with respect to the first text data: “What color model do you like?” is also equal to or higher than the threshold.

In addition, the opinion aggregation apparatus 100 determines that the first score “8.5” of the chat text data: “Red is nice” with respect to the first text data: “Do you like the red model?” is equal to or higher than the threshold and that the first score “6.5” of the chat text data: “Red is nice” with respect to the first text data: “What color model do you like?” is also equal to or higher than the threshold.

Furthermore, the opinion aggregation apparatus 100 determines that the first score “8.5” of the chat text data: “Red is iffy” with respect to the first text data: “Do you like the red model?” is equal to or higher than the threshold and that the first score “0.3” of the chat text data: “Red is iffy” with respect to the first text data: “What color model do you like?” is smaller than the threshold.

In addition, the opinion aggregation apparatus 100 determines that the first score “1.9” of the chat text data: “I love the fact that it comes in many colors” with respect to the first text data: “Do you like the red model?” is lower than the threshold and that the first score “−2.0” of the chat text data: “I love the fact that it comes in many colors” with respect to the first text data: “What color model do you like?” is also lower than the threshold.

Furthermore, the opinion aggregation apparatus 100 determines that the first score “−5.1” of the chat text data: “I'd prefer a slightly smaller size” with respect to the first text data: “Do you like the red model?” is lower than the threshold and that the first score “−6.7” of the chat text data: “I'd prefer a slightly smaller size” with respect to the first text data: “What color model do you like?” is also lower than the threshold.

For example, when there is a single piece of second text data, the opinion aggregation apparatus 100 determines whether or not a second score of chat text data with respect to the second text data is equal to or higher than a threshold. For example, when there are a plurality of pieces of second text data, the opinion aggregation apparatus 100 determines whether or not a second score of chat text data with respect to all of the pieces of second text data is equal to or higher than a threshold.

Specifically, the opinion aggregation apparatus 100 determines that the second score “8.8” of the chat text data: “What is an injection?” with respect to the second text data: “An injection refers to a fuel supply apparatus” is equal to or higher than the threshold.

In addition, the opinion aggregation apparatus 100 determines that the second score “8.5” of the chat text data: “I don't know what injection means” with respect to the second text data: “An injection refers to a fuel supply apparatus” is equal to or higher than the threshold.

Furthermore, the opinion aggregation apparatus 100 determines that the second score “0.1” of the chat text data: “It seems like a stable supply is required” with respect to the second text data: “An injection refers to a fuel supply apparatus” is lower than the threshold.

In addition, the opinion aggregation apparatus 100 determines that the second score “−5.1” of the chat text data: “I'd prefer a slightly smaller size” with respect to the second text data: “An injection refers to a fuel supply apparatus” is lower than the threshold.

In step 107, based on a determination result, the opinion aggregation apparatus 100 outputs a similar sentence that is similar to the input sentence.

For example, when there are a plurality of pieces of first text data, based on a determination result that the first score of chat text data with respect to all of the pieces of first text data is equal to or higher than the threshold, the opinion aggregation apparatus 100 outputs “I like the red model” and “Red is nice” as similar sentences that are similar to the input sentence. Specifically, with respect to first text data: “Do you like the red model?”, the opinion aggregation apparatus 100 classifies the pieces of chat text data “I like the red model”, “Red is iffy”, and “Red is nice” of which the first score is equal to or higher than the threshold into a high-order text group. In addition, with respect to first text data: “What color model do you like?”, the opinion aggregation apparatus 100 classifies the pieces of chat text data “I like the red model” and “Red is nice” of which the first score is equal to or higher than the threshold into a high-order text group. Subsequently, the opinion aggregation apparatus 100 outputs chat text data being commonly included in both high-order text groups or, in other words, “I like the red model” and “Red is nice”.

For example, when there is a single piece of second text data, based on a determination result that the second score of chat text data with respect to the second text data is equal to or higher than the threshold, the opinion aggregation apparatus 100 outputs “What is an injection?” and “I don't know what injection means” as similar sentences that are similar to the input sentence. Specifically, with respect to second text data: “An injection refers to a fuel supply apparatus”, the opinion aggregation apparatus 100 classifies the pieces of chat text data “What is an injection?” and “I don't know what injection means” of which the second score is equal to or higher than the threshold into a high-order text group. Subsequently, the opinion aggregation apparatus 100 outputs all of the pieces of chat text data included in the high-order text group or, in other words, “What is an injection?” and “I don't know what injection means”.

The opinion aggregation method according to the first embodiment classifies a similar text based on a sentence continuity score. Specifically, an input sentence is converted, whether or not a predetermined sentence establishes itself as a conversational sentence with respect to the converted input sentence is calculated as a sentence continuity score, and a conformity or a similarity between the input sentence and the predetermined sentence is measured according to the calculated score. With respect to a declarative sentence, an interrogative sentence thereof is created and a sentence continuity score between the interrogative sentence and a prescribed sentence is calculated to score a conformity between the interrogative sentence and the original declarative sentence. With respect to an interrogative sentence, an answer sentence thereof is created and a sentence continuity score between a predetermined sentence and the answer sentence is calculated to score a conformity between the answer sentence and the original interrogative sentence. Accordingly, an opinion aggregation method that enables even a short sentence to be classified based on captured semantic information only by text information can be realized.

In addition, since whether or not a sentence establishes itself as a conversational sentence is used as a classification criterion, an opinion aggregation method that enables a classification result to be readily interpreted can be realized.

### Second Embodiment

<Configuration of Opinion Aggregation Apparatus>

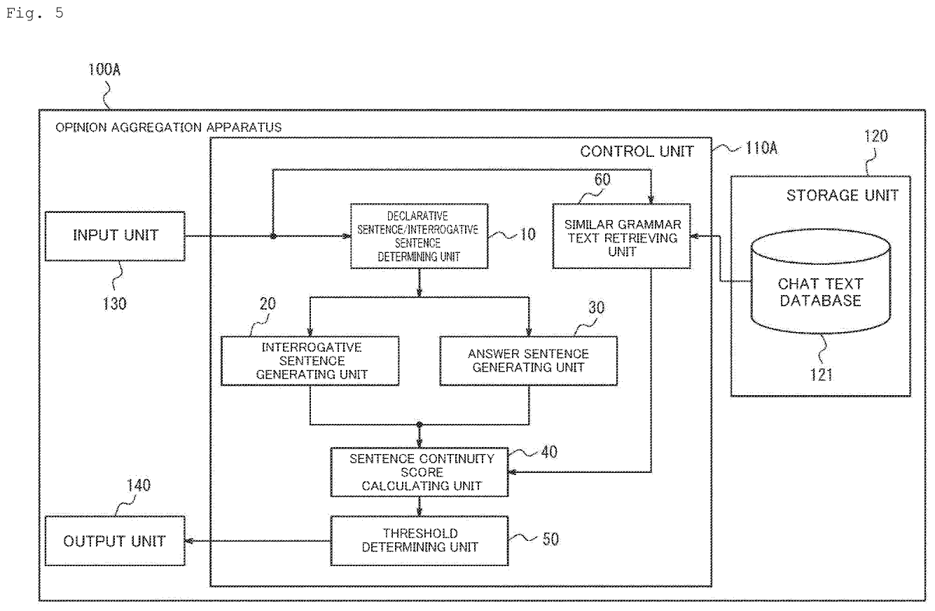

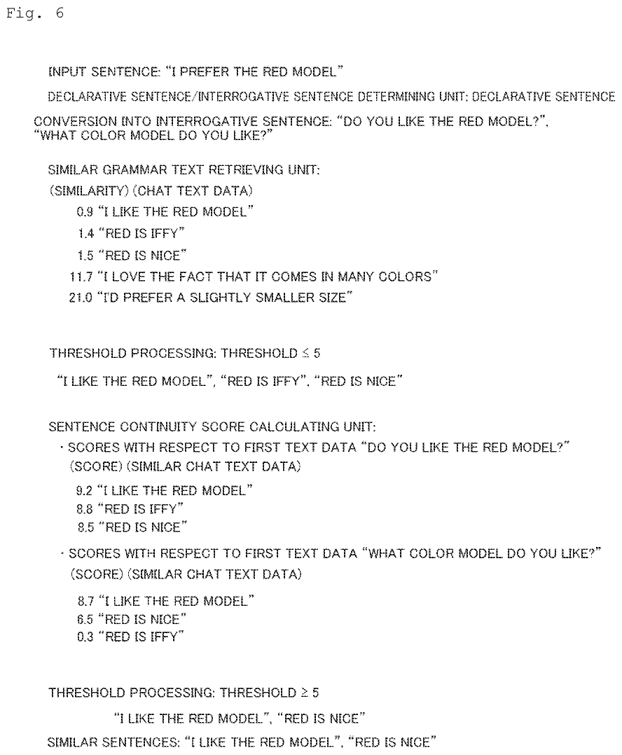

An example of a configuration of an opinion aggregation apparatus 100A according to a second embodiment will be described with reference to FIG. 5 or FIG. 6.

The opinion aggregation apparatus 100A according to the second embodiment differs from the opinion aggregation apparatus 100 according to the first embodiment in that, while the opinion aggregation apparatus 100 according to the first embodiment does not include a similar grammar text retrieving unit, the opinion aggregation apparatus 100A according to the second embodiment includes a similar grammar text retrieving unit. Since other components are similar to those of the opinion aggregation apparatus 100 according to the first embodiment, redundant descriptions may be omitted.

The opinion aggregation apparatus 100A includes a control unit 110A, the storage unit 120, the input unit 130, and the output unit 140. The control unit 110A includes the declarative sentence/interrogative sentence determining unit (first determining unit) 10, the interrogative sentence generating unit (first generating unit) 20, the answer sentence generating unit (second generating unit) 30, the sentence continuity score calculating unit (calculating unit) 40, the threshold determining unit (second determining unit) 50, and a similar grammar text retrieving unit (retrieving unit) 60.

The similar grammar text retrieving unit 60 retrieves chat text data that is grammatically similar to an input sentence from the chat text database 121. Subsequently, based on a similarity (for example, a value calculated by a distance calculation) between the input sentence and the chat text data, the similar grammar text retrieving unit 60 ranks a plurality of pieces of chat text data in an order of similarities.

For example, as shown in FIG. 6, the similar grammar text retrieving unit 60 ranks a plurality of pieces of chat text data that are grammatically similar to an input sentence: “I prefer the red model” as follows: “0.9: I like the red model”, “1.4: Red is iffy”, “1.5: Red is nice”, “11.7: I love the fact that it comes in many colors”, “21.0: I'd prefer a slightly smaller size”, and the like.

In addition, the similar grammar text retrieving unit 60 determines whether or not a similarity is equal to or lower than a threshold. When the similarity is equal to or lower than the threshold, the similar grammar text retrieving unit 60 outputs chat text data with the similarity to the sentence continuity score calculating unit 40 as similar chat text data, but when the similarity is higher than the threshold, the similar grammar text retrieving unit 60 does not output chat text data with the similarity to the sentence continuity score calculating unit 40 as similar chat text data. A value of the threshold is not particularly limited and the threshold may be set to an arbitrary value by the opinion aggregation apparatus 100A.

For example, as shown in FIG. 6, when the similarity is equal to or lower than the threshold (for example, 5.0), the similar grammar text retrieving unit 60 outputs “0.9: I like the red model”, “1.4: Red is iffy”, and “1.5: Red is nice” to the sentence continuity score calculating unit 40 as similar chat text data, but when the similarity is higher than the threshold (for example, 5.0), the similar grammar text retrieving unit 60 does not output “11.7: I love the fact that it comes in many colors” and “21.0: I'd prefer a slightly smaller size” to the sentence continuity score calculating unit 40 as similar chat text data.

Although a technique used by the similar grammar text retrieving unit 60 to retrieve chat text data that is grammatically similar to an input sentence from the chat text database 121 is not particularly limited, for example, a text may be converted into a feature vector by BERT being a model of natural language processing and a text in which a norm value indicating a difference in feature vectors is smaller than a predetermined threshold may be adopted as a retrieval result as a similar grammar text. For details of this technique, for example, refer to the following literature.

Devlin, Jacob, et al. “Bert: Pre-training of deep bidirectional transformers for language understanding.” arXiv preprint arXiv:1810.04805 (2018).

The sentence continuity score calculating unit 40 calculates a first score indicating sentence continuity between first text data input from the interrogative sentence generating unit 20 and similar chat text data input from the similar grammar text retrieving unit 60. The sentence continuity score calculating unit 40 outputs the calculated first score to the threshold determining unit 50.

In a similar manner, the sentence continuity score calculating unit 40 calculates a second score indicating sentence continuity between similar chat text data input from the similar grammar text retrieving unit 60 and second text data input from the answer sentence generating unit 30. The sentence continuity score calculating unit 40 outputs the calculated second score to the threshold determining unit 50.

Based on the first scores input from the sentence continuity score calculating unit 40, the threshold determining unit 50 ranks the plurality of pieces of similar chat text data in an order of the scores. For example, as shown in FIG. 6, the threshold determining unit 50 ranks a plurality of pieces of similar chat text data with respect to first text data: “Do you like the red model?” as follows: “9.2: I like the red model”, “8.8: Red is iffy”, “8.5: Red is nice”, and the like. For example, as shown in FIG. 6, the threshold determining unit 50 ranks a plurality of pieces of similar chat text data with respect to first text data: “What color model do you like?” as follows: “8.7: I like the red model”, “6.5: Red is nice”, “0.3: Red is iffy”, and the like.

In addition, the threshold determining unit 50 determines whether or not a first score is equal to or higher than a threshold. When the first score is equal to or higher than the threshold, the threshold determining unit 50 outputs similar chat text data with the first score to the output unit 140, but when the first score is lower than the threshold, the threshold determining unit 50 does not output similar chat text data with the first score to the output unit 140.

In a similar manner, the threshold determining unit 50 determines whether or not the second score is equal to or higher than a threshold. When the second score is equal to or higher than the threshold, the threshold determining unit 50 outputs similar chat text data with the second score to the output unit 140, but when the second score is lower than the threshold, the threshold determining unit 50 does not output similar chat text data with the second score to the output unit 140.

For example, as shown in FIG. 6, when there are a plurality of pieces of first text data, with respect to all of the pieces of first text data (for example, “Do you like the red model?” and “What color model do you like?”), the threshold determining unit 50 determines whether or not a first score of a single piece or a plurality of pieces of similar chat text data (for example, “I like the red model”, “Red is nice”, and “Red is iffy”) is equal to or higher than a threshold (for example, 5.0). In addition, the threshold determining unit 50 outputs similar chat text data (for example, “I like the red model” and “Red is nice”) of which the first score is equal to or higher than the threshold with respect to all of the pieces of first text data to the output unit 140 but does not output similar chat text data (for example, “Red is iffy”) of which the first score is not equal to or higher than the threshold with respect to all of the pieces of first text data to the output unit 140.

When an input sentence is a declarative sentence, the opinion aggregation apparatus 100A according to the second embodiment extracts an answer sentence having a high sentence continuity score with respect to a sentence obtained by converting the input sentence into an interrogative sentence, and when the input sentence is an interrogative sentence, the opinion aggregation apparatus 100A according to the second embodiment extracts an interrogative sentence having a high sentence continuity score with respect to a sentence being a simple answer to the interrogative sentence. Accordingly, since similar sentences that are similar to the input sentence can be output, the opinion aggregation apparatus 100A capable of performing classification based on captured semantic information of same opinions or same meanings can be realized. In addition, due to the sentence continuity score calculating unit 40 using only similar chat text data having been stringently selected in advance for score calculation, the opinion aggregation apparatus 100A capable of efficiently performing classification based on captured semantic information while suppressing calculation cost can be realized.

<Opinion Aggregation Method>

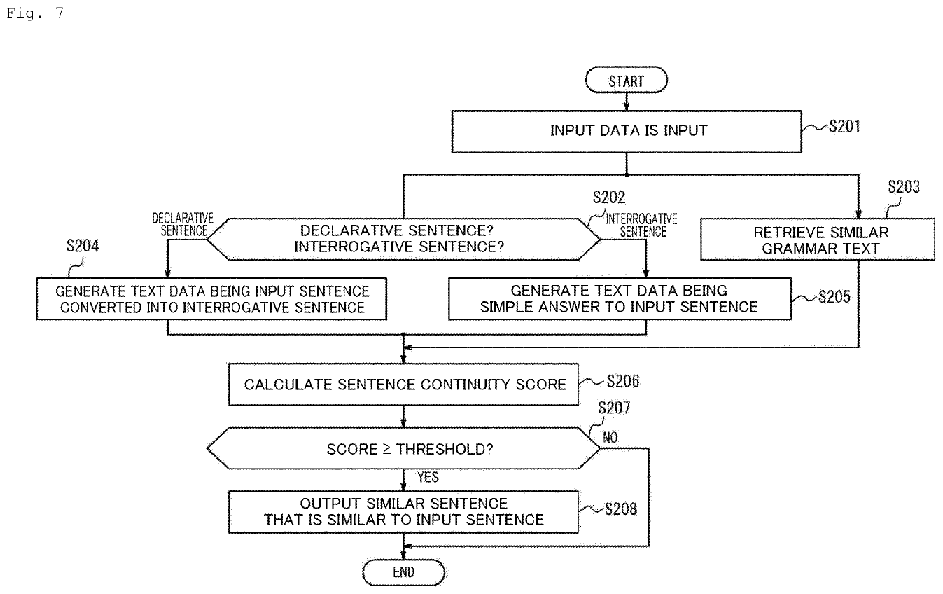

An example of an opinion aggregation method according to the second embodiment will be described with reference to FIG. 7. Redundant descriptions of processing similar to that of the opinion aggregation method according to the first embodiment may be omitted.

In step S201, an input sentence is input to the opinion aggregation apparatus 100A. Examples of the input sentence include “I prefer the red model”.

In step 202, the opinion aggregation apparatus 100A determines whether the input sentence is a declarative sentence or an interrogative sentence. When the input sentence is a declarative sentence (step 202→declarative sentence), the opinion aggregation apparatus 100A performs processing of step 204. When the input sentence is an interrogative sentence (step 202→interrogative sentence), the opinion aggregation apparatus 100A performs processing of step 205.

In step 203, the opinion aggregation apparatus 100A retrieves chat text data that is grammatically similar to the input sentence from the chat text database 121. In addition, the opinion aggregation apparatus 100A determines whether or not a similarity between the input sentence and the chat text data is equal to or lower than a threshold, and when the similarity is equal to or lower than the threshold, chat text data with the similarity is adopted as similar chat text data.

For example, the opinion aggregation apparatus 100A determines that a similarity: “0.9” of retrieved chat text data: “I like the red model” is equal to or lower than the threshold and adopts the retrieved chat text data: “I like the red model” as similar chat text data. For example, the opinion aggregation apparatus 100A determines that a similarity: “1.4” of retrieved chat text data: “Red is iffy” is equal to or lower than the threshold and adopts the retrieved chat text data: “Red is iffy” as similar chat text data. For example, the opinion aggregation apparatus 100A determines that a similarity: “1.5” of retrieved chat text data: “Red is nice” is equal to or lower than the threshold and adopts the retrieved chat text data: “Red is nice” as similar chat text data. For example, the opinion aggregation apparatus 100A determines that a similarity: “11.7” of retrieved chat text data: “I love the fact that it comes in many colors” is higher than the threshold and does not adopt the retrieved chat text data: “I love the fact that it comes in many colors” as similar chat text data. For example, the opinion aggregation apparatus 100A determines that a similarity: “21.0” of retrieved chat text data: “I'd prefer a slightly smaller size” is higher than the threshold and does not adopt the retrieved chat text data: “I'd prefer a slightly smaller size” as similar chat text data.

In step 204, the opinion aggregation apparatus 100A converts the input sentence into an interrogative sentence and generates first text data that is text data obtained by converting the input sentence into an interrogative sentence.

In step 205, the opinion aggregation apparatus 100A prepares a simple answer to the input sentence and generates second text data being text data of the simple answer to the input sentence.

In step 206, the opinion aggregation apparatus 100A calculates a sentence continuity score. For example, the opinion aggregation apparatus 100A calculates a first score indicating sentence continuity between the first text data and similar chat text data. For example, the opinion aggregation apparatus 100A calculates a second score indicating sentence continuity between similar chat text data and the second text data.

For example, using first text data: “Do you like the red model?” as a first piece of text data and similar chat text data: “I like the red model” as a second piece of text data, the opinion aggregation apparatus 100A calculates a first score indicating a continuity between the two sentences as “9.2”.

For example, using first text data: “Do you like the red model?” as a first piece of text data and similar chat text data: “Red is iffy” as a second piece of text data, the opinion aggregation apparatus 100A calculates a first score indicating a continuity between the two sentences as “8.8”.

For example, using first text data: “Do you like the red model?” as a first piece of text data and similar chat text data: “Red is nice” as a second piece of text data, the opinion aggregation apparatus 100A calculates a first score indicating a continuity between the two sentences as “8.5”.

For example, using first text data: “What color model do you like?” as a first piece of text data and similar chat text data: “I like the red model” as a second piece of text data, the opinion aggregation apparatus 100A calculates a first score indicating a continuity between the two sentences as “8.7”.

For example, using first text data: “What color model do you like?” as a first piece of text data and similar chat text data: “Red is nice” as a second piece of text data, the opinion aggregation apparatus 100A calculates a first score indicating a continuity between the two sentences as “6.5”.

For example, using first text data: “What color model do you like?” as a first piece of text data and similar chat text data: “Red is iffy” as a second piece of text data, the opinion aggregation apparatus 100A calculates a first score indicating a continuity between the two sentences as “0.3”.

In step 207, based on the first scores or the second scores, the opinion aggregation apparatus 100A ranks the plurality of pieces of similar chat text data in an order of the scores.

For example, the opinion aggregation apparatus 100A ranks a plurality of pieces of similar chat text data with respect to the first text data: “Do you like the red model?” as follows: “9.2: I like the red model”, “8.8: Red is iffy”, “8.5: Red is nice”, and the like.

For example, the opinion aggregation apparatus 100A ranks a plurality of pieces of similar chat text data with respect to the first text data: “What color model do you like?” as follows: “8.7: I like the red model”, “6.5: Red is nice”, “0.3: Red is iffy”, and the like.

Subsequently, the opinion aggregation apparatus 100A determines whether or not the first score or the second score is equal to or higher than a threshold. When the first score or the second score is equal to or higher than the threshold (step 207→YES), the opinion aggregation apparatus 100A performs processing of step 208. When the first score or the second score is lower than the threshold (step 207→NO), the opinion aggregation apparatus 100A ends processing.

For example, when there is a single piece of first text data, the opinion aggregation apparatus 100A determines whether or not a first score of similar chat text data with respect to the first text data is equal to or higher than a threshold. For example, when there are a plurality of pieces of first text data, the opinion aggregation apparatus 100A determines whether or not a first score of similar chat text data with respect to all of the pieces of first text data is equal to or higher than a threshold.

For example, when there is a single piece of second text data, the opinion aggregation apparatus 100A determines whether or not a second score of similar chat text data with respect to the second text data is equal to or higher than a threshold. For example, when there are a plurality of pieces of second text data, the opinion aggregation apparatus 100A determines whether or not a second score of similar chat text data with respect to all of the pieces of second text data is equal to or higher than a threshold.

Specifically, the opinion aggregation apparatus 100A determines that the first score “9.2” of the similar chat text data: “I like the red model” with respect to the first text data: “Do you like the red model?” is equal to or higher than the threshold and that the first score “8.7” of the similar chat text data: “I like the red model” with respect to the first text data: “What color model do you like?” is also equal to or higher than the threshold.

In addition, the opinion aggregation apparatus 100A determines that the first score “8.5” of the similar chat text data: “Red is nice” with respect to the first text data: “Do you like the red model?” is equal to or higher than the threshold and that the first score “6.5” of the similar chat text data: “Red is nice” with respect to the first text data: “What color model do you like?” is also equal to or higher than the threshold.

Furthermore, the opinion aggregation apparatus 100A determines that the first score “8.5” of the similar chat text data: “Red is iffy” with respect to the first text data: “Do you like the red model?” is equal to or higher than the threshold and that the first score “0.3” of the similar chat text data: “Red is iffy” with respect to the first text data: “What color model do you like?” is smaller than the threshold.

In step 208, based on a determination result, the opinion aggregation apparatus 100A outputs a similar sentence that is similar to the input sentence.

For example, when there are a plurality of pieces of first text data, based on a determination result that the first score of chat text data with respect to all of the pieces of first text data is equal to or higher than the threshold, the opinion aggregation apparatus 100A outputs “I like the red model” and “Red is nice” as similar sentences that are similar to the input sentence. Specifically, with respect to first text data: “Do you like the red model?”, the opinion aggregation apparatus 100A classifies the pieces of similar chat text data “I like the red model”, “Red is iffy”, and “Red is nice” of which the first score is equal to or higher than the threshold into a high-order text group. In addition, with respect to first text data: “What color model do you like?”, the opinion aggregation apparatus 100A classifies the pieces of similar chat text data “I like the red model” and “Red is nice” of which the first score is equal to or higher than the threshold into a high-order text group. Subsequently, the opinion aggregation apparatus 100A outputs similar chat text data being commonly included in both high-order text groups or, in other words, “I like the red model” and “Red is nice”.

The opinion aggregation method according to the second embodiment classifies a similar text based on a sentence continuity score. Specifically, an input sentence is converted, whether or not a predetermined similar sentence establishes itself as a conversational sentence with respect to the converted input sentence is calculated as a sentence continuity score, and a conformity or a similarity between the input sentence and the predetermined similar sentence is measured according to the calculated score. With respect to a declarative sentence, an interrogative sentence thereof is created and a sentence continuity score between the interrogative sentence and a prescribed similar sentence is calculated to score a conformity between the interrogative sentence and the original declarative sentence. With respect to an interrogative sentence, an answer sentence thereof is created and a sentence continuity score between a predetermined similar sentence and the answer sentence is calculated to score a conformity between the answer sentence and the original interrogative sentence. Accordingly, an opinion aggregation method that enables even a short sentence to be classified based on captured semantic information only by text information can be realized. Furthermore, an opinion aggregation method that enables calculation cost to be suppressed can be realized. In addition, since whether or not a sentence establishes itself as a conversational sentence is used as a classification criterion, an opinion aggregation method that enables a classification result to be readily interpreted can be realized.

<Modifications>

The present invention is not limited to the embodiments and modifications described above. For example, various processing steps described above may not only be executed in a time series in accordance with the description but may also be executed in parallel or individually depending on a processing capacity of an apparatus executing the processing or as the need arises. Otherwise, various changes can be made as necessary without departing from the gist of the present invention.

<Program and Recording Medium>

A computer capable of executing program instructions to function as the embodiments or modifications described above can also be used. In this case, the computer may be any of a general-purpose computer, a dedicated computer, a work station, a PC (Personal Computer), an electronic notepad, and so on. The program instructions may be program codes, code segments, or the like for executing necessary tasks. A processor that functions as the control units 110 and 110A is a CPU (Central Processing Unit), an MPU (Micro Processing Unit), a GPU (Graphics Processing Unit), a DSP (Digital Signal Processor), an SoC (System on a Chip), or the like and may be constituted of a plurality of processors of a same type or different types. The control units 110 and 110A read the program from the storage unit 120 and execute the program in order to control the respective components and perform various arithmetic processing steps described above. It should be noted that at least a part of the processing contents may be realized by hardware.

For example, referring to FIG. 4, a program for causing a computer to execute the opinion aggregation method described above at least includes the steps of: determining whether an input sentence is a declarative sentence or an interrogative sentence (S101, S102); generating, when the input sentence is the declarative sentence, first text data being the input sentence converted into an interrogative sentence (S103); generating, when the input sentence is the interrogative sentence, second text data being a simple answer to the input sentence (S104); calculating a first score indicating sentence continuity between the first text data and the chat text data or a second score indicating sentence continuity between the chat text data and the second text data (S105); and outputting, when the first score or the second score is equal to or higher than a threshold, the chat text data with the first score or the second score (S106, S107).

In addition, the program may be recorded on a computer-readable recording medium. With the use of such a recording medium, the program can be installed into a computer. In this case, the recording medium in which the program is recorded may be a non-transitory recording medium. The non-transitory recording medium may be a CD (Compact Disk)-ROM (Read-Only Memory), a DVD (Digital Versatile Disc)-ROM, a BD (Blue-Ray (registered trademark) Disc)-ROM, or the like. Furthermore, the program can also be provided through download via a network.

While embodiments have been described above as typical examples, it is obvious to a person skilled in the art that many modifications and substitutions can be made without departing from the gist and scope of the present disclosure. Therefore, the embodiments described above should not be construed to limit the present invention, and the present invention can be modified and changed in various ways without departing from the scope of the claims. For example, a plurality of component blocks shown in configuration diagrams of the embodiments may be combined into one component block, or one component block may be divided into component blocks. In addition, a plurality of steps shown in the flowcharts of the embodiments may be combined into one flowchart, or one step may be divided into steps.

### REFERENCE SIGNS LIST

10 Declarative sentence/interrogative sentence determining unit (first determining unit)
20 Interrogative sentence generating unit (first generating unit)
30 Answer sentence generating unit (second generating unit)
40 Sentence continuity score calculating unit (calculating unit)
50 Threshold determining unit (second determining unit)
60 Similar grammar text retrieving unit (retrieving unit)
100, 100A Opinion aggregation apparatus
110, 110A Control unit
120 Storage unit
130 Input unit
140 Output unit

1. An opinion aggregation apparatus comprising a processor configured to execute operations comprising:
determining a type of a plurality of types of sentences associated with an input sentence;
generating, based on the determined type of the plurality of types of sentences, text data;
storing a chat text database including a plurality of pieces of chat text data;
calculating, based on sentence continuity between the text data and the chat text data, a score and
outputting, based on the score relative to a predetermined threshold, the chat text data with the score.

2. The opinion aggregation apparatus according to claim 1, wherein the text data includes a plurality of pieces of texts, and
the outputting further comprises:
outputting the chat text data of which the score is equal to or higher than the predetermined threshold with respect to all of the pieces of texts of the plurality of texts in text data.

3. An opinion aggregation apparatus comprising a processor configured to execute operations comprising:
determining a type of a plurality of types of sentences associated with an input sentence;
generating, based on the input sentence and the determined type of the plurality of types of sentences, text data;
storing a chat text database including a plurality of pieces of chat text data;
retrieving chat text data as similar chat text data from the chat database, wherein the similar chat text data is grammatically similar to the input sentence;
calculating, based on sentence continuity between the text data and the similar chat text data, a score; and
outputting, based on the score relative to a predetermined threshold, the similar chat text data with the score.

4. The opinion aggregation apparatus according to claim 3, wherein the text data includes a plurality of pieces of texts, and
the outputting further comprises:
outputting the similar chat text data of which the score is equal to or higher than the predetermined threshold with respect to all of the pieces of texts of the plurality of texts in the text data.

5. A computer-implemented method for aggregating opinions, comprising:
determining a type of a plurality of types of sentences associated with an input sentences;
generating, based on the input sentence and the determined type of the plurality of types of sentences, text data;
storing a chat text database including a plurality of pieces of chat text data;
calculating, based on sentence continuity between the text data and the chat text data, a score; and
outputting, based on the score relative to a predetermined threshold, the chat text data with the score.

6-7. (canceled)

8. The opinion aggregation apparatus according to claim 1, wherein the determined type of the plurality of types of sentences includes a declarative sentence type,
the generating the text data further comprises converting the input sentence into the text data as an interrogative sentence,
the sentence continuity is between the text data and the chat text data, and
the score is equal to or higher than the predetermined threshold.

9. The opinion aggregation apparatus according to claim 1, wherein the determined type of the plurality of types of sentences includes an interrogative sentence type,
the text data represents an answer to the input sentence,
the sentence continuity is between the text data and the chat text data, and
the score is equal to or higher than the predetermined threshold.

10. The opinion aggregation apparatus according to claim 8, wherein the score is based on a conformity between the interrogative sentence and a predetermined sentence.

11. The opinion aggregation apparatus according to claim 9, wherein the score is based on a conformity between the answer sentence and a predetermined sentence.

12. The opinion aggregation apparatus according to claim 3, wherein the determined type of the plurality of types of sentences includes a declarative sentence type,
the generating the text data further comprises converting the input sentence into the text data as an interrogative sentence,
the sentence continuity is between the text data and the similar chat text data, and
the score is equal to or higher than the predetermined threshold.

13. The opinion aggregation apparatus according to claim 3, wherein the determined type of the plurality of types of sentences includes an interrogative sentence type,
the text data represents an answer to the input sentence,
the sentence continuity is between the text data and the similar chat text data, and
the score is equal to or higher than the predetermined threshold.

14. The computer-implemented method according to claim 5, wherein the determined type of the plurality of types of sentences includes a declarative sentence type,
the generating the text data further comprises converting the input sentence into the text data as an interrogative sentence,
the sentence continuity is between the text data and the chat text data, and
the score is equal to or higher than the predetermined threshold.

15. The computer-implemented method according to claim 5, wherein the determined type of the plurality of types of sentences includes an interrogative sentence type,
the text data represents an answer to the input sentence,
the sentence continuity is between the text data and the chat text data, and
the score is equal to or higher than the predetermined threshold.

16. The computer-implemented method according to claim 14, wherein the score is based on a conformity between the interrogative sentence and a predetermined sentence.

17. The computer-implemented method according to claim 15, wherein the score is based on a conformity between the answer sentence and a predetermined sentence.
